(19) United States
(12) Patent Application Publication
(10) Pub. No.: US 2003/0062637 A1
(43) Pub. Date: Apr. 3, 2003

(54) Method and apparatus for recoating optical fiber

(76) Inventors: John C. Alden, Londonderry, NH (US); Kevin L. Patenaude, Dracut, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/969,555

(22) Filed: Oct. 2, 2001

(51) Int. Cl. B29D 11/00

(52) U.S. Cl. 264/1.27; 425/116

(57) ABSTRACT

An optical fiber recoater for recoating a portion of an optical fiber, such as an optical fiber splice, that has been stripped of or otherwise lacks a protective coating. The recoater may be configured to accommodate optical fibers of varying diameters without the need to reconfigure the device each time the size of the fiber to be recoated increases or decreases. The recoater may be configured to progressively cure coating material within the mold about the optical fiber in a controlled manner. The recoater may be provided with an ejector arrangement that is configured to dislodge the cured material from the mold prior to its removal. The recoater may also be provided with the capability to proof test the integrity of an optical fiber splice. The recoater may be computer controlled and provide for automatic recoating of an exposed fiber portion. The recoater may be implemented as part of an automated system configured to automatically interconnect one or more pairs of optical fibers using a fusion splicing process. In this regard, the recoater may be configured to automatically recoat an optical fiber splice as part of the overall automated splicing process.

### FIELD OF THE INVENTION

The present invention relates to an apparatus and to a method for automatically coating or recoating a portion of an optical fiber, such as an optical fiber splice.

### BACKGROUND OF THE INVENTION

Optical devices are becoming increasingly popular, particularly for use in networking applications. In an optical network, circuit, or other application, optical devices are interconnected using optical fibers, which serve as the transmission medium for transmitting information between the devices. To form an optical circuit, one or more pairs of optical fibers, such as optical fiber pigtails, are connected to each other. The interconnection between the fibers may be accomplished using fusion splicing techniques known in the art.

Fusion splicing of optical fibers conventionally requires that each fiber to be spliced first undergoes one or more fiber preparation processes, including stripping the protective coating from an end portion of each fiber, cleaning the stripped fiber, and cleaving the end of the fiber. Once the fiber ends are spliced, it is generally desirable to apply a protective layer to the stripped portion of the fiber. An optical fiber splice is typically covered and protected either with a molded plastic coating or a splint/heat shrink tubing arrangement placed over the stripped portion of the fiber. The protective layer provides both structural strength and protection to the spliced portion of the fiber.

Recoating the optical fiber with a molded coating may involve injecting a UV-curable polymer into a mold about the desired region of the optical fiber. The polymer may be cured using a light source to form a protective coating about the fiber. In some instances, uncured polymer may need to be cleaned from the mold prior to recoating another fiber.

It is an object of the present invention to provide an improved optical fiber recoater and a method of recoating an optical fiber.

### SUMMARY OF THE INVENTION

In one illustrative embodiment, an optical fiber recoater comprises a mold having a mold cavity adapted to enclose a length of optical fiber along a molding axis. The mold is adapted to receive a light curable coating material in the molding cavity to form a protective coating on the length of optical fiber, and is constructed and arranged to pass light through the molding cavity to expose and cure the coating material. The recoater further comprises a light guide supported adjacent the mold, the light guide being constructed and arranged to emit a light beam onto at least first and second portions of the mold to expose and cure at least first and second portions of the coating material in the molding cavity with the light beam. At least one of the mold and the light guide is movable relative to the other of the mold and the light guide to expose the at least first and second portions of the mold, respectively, at a first time and at a second time that is different from the first time to progressively cure the at least first and second portions of the coating material at the first and second times to form the protective coating.

In another illustrative embodiment, a method is provided for recoating a length of optical fiber. The method comprises: enclosing the length of optical fiber within a molding cavity of a mold along a molding axis; dispensing a coating material into the molding cavity to form a protective coating on the length of optical fiber; exposing a first portion of the mold with a light beam to cure a first portion of the coating material; moving at least one of the mold and the light beam relative to the other of the mold and the light beam; and exposing a second portion of the mold with the light beam to cure a second portion of the coating material to form the protective coating.

In a further embodiment, an optical fiber recoater comprises a mold having a mold cavity adapted to enclose a length of optical fiber along a molding axis. The mold is adapted to receive a coating material in the molding cavity to form a protective coating on the length of optical fiber. The recoater also comprises an ejector that is coupled to the mold. The ejector is constructed and arranged to dislodge the protective coating from the mold in response to a control signal.

In another embodiment, a method is provided for recoating a length of optical fiber. The method comprises: enclosing the length of optical fiber within a molding cavity of a mold; dispensing a coating material into the molding cavity; curing the coating material to form a protective coating on the length of optical fiber; and exerting a force on the protective coating within the molding cavity to separate the protective coating from the mold in response to a control signal.

In a further embodiment, an optical fiber recoater comprises a mold having a mold cavity adapted to enclose a length of optical fiber along a molding axis. The mold is adapted to receive a light curable coating material in the molding cavity to form a protective coating on the length of optical fiber, and is constructed and arranged to pass light through the molding cavity to expose and cure the coating material. The recoater also comprises a shuttered light source constructed and arranged to emit a light beam onto the mold to expose and cure the coating material in the molding cavity with the light beam. The shuttered light source includes a light shutter that is operable between open and closed positions in response to a control signal to selectively expose the mold with the light beam when the light shutter is in the open position.

In still another embodiment, an optical fiber recoater comprises a mold having a mold cavity adapted to individually enclose each of a plurality of optical fibers along a molding axis, each of the plurality of optical fibers having an outer diameter that differs from an outer diameter of others of the plurality of optical fibers. The mold is adapted to receive a coating material in the molding cavity to form a protective coating on a length of each of the plurality of optical fibers. The recoater further comprises first and second fiber supports that are disposed adjacent first and second ends of the mold. The first and second fiber supports are constructed and arranged to support the length of each of the plurality of optical fibers along the molding axis.

In still a further embodiment, an optical fiber recoater comprises a mold having a mold cavity adapted to enclose a length of optical fiber along a molding axis. The mold is adapted to receive a coating material in the molding cavity to form a protective coating on the length of optical fiber. The mold includes first and second ends spaced apart along the molding axis, and the molding cavity extends to and through the first and second ends of the mold. The mold cavity is free of a seal from the first end to the second end of the mold along the molding axis. The recoater also comprises first and second fiber supports that are disposed adjacent the first and second ends of the mold. The first and second fiber supports are constructed and arranged to support the length of optical fiber along the molding axis.

In yet another embodiment, an optical fiber recoater comprises a mold having a mold cavity adapted to enclose a length of optical fiber along a molding axis. The mold is adapted to receive a coating material in the molding cavity to form a protective coating on the length of optical fiber. The mold includes a first mold and a second mold disposed opposite each other with the molding axis therebetween. Each of the first and second molds is movable toward the molding axis to enclose the length of optical fiber in the molding cavity and away from the molding axis to release the length of optical fiber from the molding cavity. The recoater further comprises first and second fiber supports that are disposed adjacent first and second ends of the mold. The first and second fiber supports are constructed and arranged to support the length of optical fiber along the molding axis as the first and second molds are moved toward and away from the molding axis.

In yet a further embodiment, an optical fiber recoater comprises a mold having a mold cavity adapted to enclose a length of optical fiber along a molding axis, the mold being adapted to receive a coating material in the molding cavity to form a protective coating on the length of optical fiber. The recoater also comprises a tension tester constructed and arranged to induce a predetermined amount of axial tension on the length of optical fiber. The tension tester includes first and second clamps disposed adjacent first and second ends of the mold to clamp onto first and second end portions of the optical fiber extending outwardly from the first and second ends of the mold. Each of the first and second clamps includes a pair of flat clamp surfaces that are configured to clamp the first and second portions of the optical fiber therebetween.

In still another embodiment, an optical fiber recoater comprises a mold having a mold cavity adapted to enclose a length of optical fiber along a molding axis, the mold being adapted to receive a coating material in the molding cavity to form a protective coating on the length of optical fiber. The recoater further comprises first and second centralizing clamps disposed adjacent first and second ends of the mold. The first and second centralizing clamps are constructed and arranged to position each of a plurality of optical fibers coaxial with the molding axis, each of the plurality of optical fibers having an outer diameter that differs from an outer diameter of others of the plurality of optical fibers.

### BRIEF DESCRIPTION OF THE DRAWINGS

The invention will be appreciated more fully with reference to the following detailed description of illustrative embodiments thereof, when taken in conjunction with the accompanying drawings, wherein like reference characters denote like features, in which:

FIG. 1 is a schematic view of an optical fiber recoating device according to one illustrative embodiment of the invention;

FIG. 2 is a perspective view of a fiber recoating module according to one illustrative embodiment of the invention;

FIG. 3 is a perspective view of a fiber mold assembly according to one illustrative embodiment of the invention;

FIG. 4 is a side view of the embodiment of FIG. 3;

FIG. 5 is a perspective view of a fiber mold in a closed position according to one illustrative embodiment of the invention;

FIG. 6 is a side view of a fiber support according to one illustrative embodiment of the invention;

FIG. 7 is a perspective view of the fiber support of FIG. 6; and

FIG. 8 is a perspective view of a transport system for a recoating module according to one illustrative embodiment of the invention.

### DETAILED DESCRIPTION

The present invention is directed to an optical fiber recoater for recoating a portion of an optical fiber, such as an optical fiber splice, that has been stripped of or otherwise lacks a protective coating. The recoater may be implemented as part of an automated system configured to automatically interconnect one or more pairs of optical fibers using a fusion splicing process. In this regard, the recoater may be configured to automatically recoat an optical fiber splice as part of the overall automated splicing process. The recoater may also be configured as a stand-alone module for recoating optical fibers that have been spliced either manually or using a separate splicing system or device. It is also contemplated that the recoater may be used to form an additional layer of protective coating on a portion of optical fiber.

The recoater may be configured to accommodate optical fibers of varying diameters without the need to reconfigure the device each time the size of the fiber to be recoated increases or decreases. In this regard, the recoater may employ a mold that is configured to accommodate optical fibers having any of a range of diameters. The recoater may also be configured to maintain each of the optical fibers along a predetermined molding axis relative to the mold regardless of the fiber diameter.

Coating material, such as UV-curable polymers, has a tendency to shrink as it is cured within a mold. Allowing the recoating material to cure in an uncontrolled manner may result in voids being formed in the protective coating. Accordingly, the recoater may be configured to progressively cure the coating material within the mold about the optical fiber in a controlled manner to reduce the incidence of forming voids in the protective coating, which may enhance the integrity of the coating.

The coating material may also have a tendency to adhere to the mold as it is cured. When such a condition occurs during a recoating process, damage to the fiber could result during its removal from the mold. Thus, the recoater may be provided with an ejector arrangement that is configured to dislodge the cured material from the mold prior to its removal.

The recoater may also be provided with the capability to proof test the integrity of the optical splice. In this regard, the recoater may include a fiber tensioning arrangement that subjects the recoated optical splice to a predetermined amount of axial tension. The tension tester may employ clamps configured with opposed flat clamping surfaces for gripping the optical fiber in a manner that avoids point loads on the fiber by distributing clamping loads over a relatively large length of fiber. The flat clamping surfaces may be configured to accommodate some misalignment of the fiber with the clamps. The flat clamping surfaces may also reduce fiber slack that may otherwise be needed for clamps having curved clamping surfaces.

While the recoater is particularly suited for recoating optical fiber, it is to be appreciated that the recoater may be employed with any type of fiber, wire, cable or cable-like device that may benefit from receiving a protective coating.

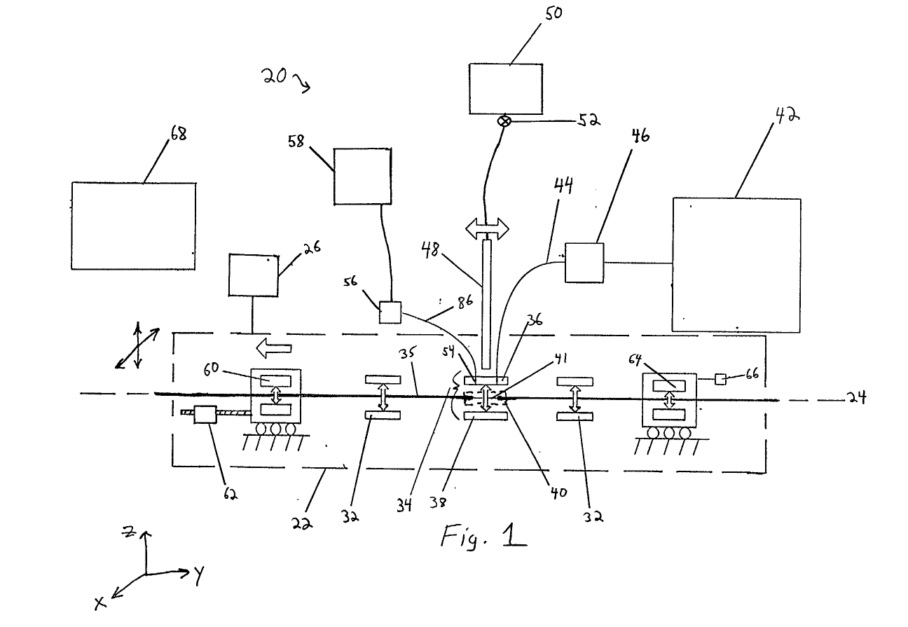

FIG. 1 is a schematic representation of one illustrative embodiment of an optical fiber recoater 20. The fiber recoater 20 includes a recoater module 22 that may be positioned relative to a predetermined molding axis 24. The recoater module 22 may be coupled to one or more drive mechanisms 26 that are configured to move the recoater module 22 in one or more directions relative to the molding axis 24. This may be particularly advantageous when incorporating the recoater 20 in an automated manufacturing system. It is to be appreciated, however, that the recoater module 22 may be configured to be maintained in a fixed position relative to the molding axis 24.

The recoater module 22 includes a pair of fiber supports 32 and a recoat mold 34 positioned between the fiber supports 32. The fiber supports 32 are configured to grasp and maintain an optical fiber 35 along the molding axis 24 during the recoat process. In this regard, once an optical fiber 35 and the recoater module 22 are positioned on the molding axis 24, the fiber supports 32 may be actuated to close about and grasp the fiber 35.

The fiber supports 32 may be configured to grasp and accurately position, along the molding axis 24, optical fibers having any of a plurality of diameters. In one embodiment, the fiber supports 32 may be configured to accommodate optical fibers having an outer diameter that ranges from approximately 180 microns to approximately 900 microns with a glass diameter of approximately 125 microns. It is to be appreciated, however, that the fiber supports 32 may be configured to grasp and position optical fibers of any size.

The recoat mold 34 includes a pair of corresponding mold portions, an upper mold 36 and a lower mold 38, that are moveable toward and away from each other and the molding axis 24 between open and closed positions. In the closed position, the upper and lower molds 26 and 38 form a molding cavity 40 about a selected portion of fiber, such as a stripped portion 41, positioned along the molding axis 24. The molding cavity 40 is adapted to receive and mold a coating material about the selected portion of the fiber.

Similar to the fiber supports 32, the recoat mold 34 may be configured to mold a protective coating of material about optical fibers having any of a plurality of fiber diameters. In this regard, the mold cavity 40 may be sized to accommodate any desirable maximum diameter fiber. The mold cavity 40 may then be used to mold a protective coating about fibers of lesser diameter. In one embodiment, the recoat mold 34 may be configured to accommodate optical fibers having an outer diameter that ranges from approximately 180 microns to approximately 900 microns with a glass diameter of approximately 125 microns. It is to be appreciated, however, that the mold may be configured to recoat optical fibers of any size.

To facilitate its use with multiple diameter fibers, the mold 34 may be configured with a seal-less mold cavity, i.e., a mold cavity 40 that employs no seals at least at its axial ends for maintaining coating material within the mold. Rather, the mold 34 relies at least in part on the surface tension between the coating material and the mold 34 to maintain the material within the cavity 40. It is to be appreciated, however, that any mold configuration may be employed with the recoater 20.

Once the optical fiber 35 is positioned on the molding axis and the mold 34 is closed around the desired portion of fiber, a coating material, such as a UV-curable polymer, is delivered to the mold cavity. In one embodiment, the mold 34 is coupled to a fluid reservoir 42 capable of holding a relatively large volume of coating material for recoating multiple optical fibers. The reservoir 42 may be pressurized to inject material into the mold cavity 40 through a hose or other fluid conduit 44. A fluid dispense valve 46 may be provided between the fluid reservoir 42 and the mold 34 to regulate the timing and the amount of material delivered to the mold cavity 40. The particular configuration of the coating material delivery system is not a limitation of the invention as any suitable delivery system may be implemented with the recoater 20.

Once recoating material is deposited in the mold cavity 40 about the fiber 35, it may be desirable to accelerate curing of the coating for enhanced system throughput. In one embodiment, the recoater 20 is configured to utilize a UV-curable coating material that is to be subjected to UV light to accelerate the curing cycle of the material. The mold 34 is formed of a transparent or translucent material that allows UV light to pass therethrough so as to expose the coating material in the molding cavity 40 to the light. A light guide 48 may be provided adjacent the mold 34 to direct a beam of light through the mold from a remote light source 50. This configuration may provide particular advantages for an automated recoat system by offloading the weight and volume of the light source 50 from the recoat module. It is to be understood, however, that the light guide 48 itself may include the light source 50 or the recoater may be provided with the light source 50 as part of the recoat module 22.

To enhance the integrity of the protective coating, the recoat module 22 may be configured to progressively cure the coating material within the mold cavity 40, rather than attempting to cure the entire amount of coating material simultaneously. In one embodiment, the light guide 48 is configured to expose a selected portion of the mold cavity 40 so that only coating material within that portion of the cavity 40 is cured. To fully cure the coating material within the entire cavity 40, the light guide 48 and the mold are movable relative to each other so that the light guide 48 eventually exposes the coating material along the entire length of the mold 34 resulting in a fully cured protective coating. Progressively curing the coating material in this manner may reduce the incidence of forming voids in the protective coating.

As illustrated, the light guide 48 may be configured to sweep along the length of the mold 34 to cure the coating material. Although a single sweep of the light guide 48 for curing the coating material may be desirable to enhance fiber recoating throughput, multiple sweeps may be employed to cure the material. It is also to be appreciated that the mold 34 may be moved relative to the light guide 48, or both the light guide 48 and the mold 34 may be moved relative to each other to progressively cure the coating material. It is also contemplated that the light guide 48 may be rotated around the mold 34 to project light onto the mold from different directions, or a plurality of light guides 48 may be provided along the mold.

Since exposure of the mold cavity with UV light is typically desirable only when curing the coating material, the recoater 20 may be configured so that the mold is exposed to UV light only during the curing phase of the recoating process. In one embodiment, the recoater 20 is provided with a shuttered light source 50 in which the light source 50 remains continuously illuminated and exposure of the mold to the light is controlled with a shutter 52 located at the light source 50 or somewhere between the light source 50 and the mold. By selectively opening and closing the shutter 52 during the recoating process, it is possible to limit exposure of the mold 34 to the light source 50 so that it occurs only during the curing phase.

The shuttered light arrangement may be particularly suited for an automated recoating process which may entail numerous curing cycles in a relatively short amount of time. Cycling the light source 50 itself on and off may lead to its premature failure. Additionally, cycling the light source 50 on and off may increase the overall cycle time of the curing process. It is to be appreciated, however, that the invention is not limited to a shuttered light source as other arrangements may be implemented for controlling the illumination of the mold 34. For example, the recoater 20 may employ a light source 50 that is selectively cycled on and off during the recoating process, despite the several drawbacks discussed above. As another example, the recoater 20 may be configured with a light guide 48 that is movable away from the mold 34 when it is desired to avoid illumination of the mold 34 with the light source 50.

Once the coating material has been cured, it may be desirable to dislodge any cured material that may have become adhered to the mold so as to facilitate removal of the recoated fiber from the mold 34. Consequently, the recoater 20 may be provided with an ejector arrangement that is configured to dislodge any portion of the cured material or fiber that may have become adhered to the mold 34 during the recoating process. In one embodiment, the mold 34 includes an air ejector 54 that delivers a pulse of pressurized air to the molding cavity 40 through one or more ejector ports in the upper and lower molds 36 and 38. The pressurized air exerts a force on the protective coating and fiber within the cavity that separates the coating and fiber from the mold 34. An ejector valve 56 may be provided to control the flow of pressurized air from an air source 58 to the mold 34.

While an air ejector arrangement may provide one or more particular advantages, such as a relatively uniform pressure distribution on the molded fiber, the present invention is not limited to any particular ejector configuration. In this regard, it is to be understood that other arrangements for ejecting the fiber from the mold 34 may be implemented with the recoater 20. For example, the mold may include one or more ejector pins that are moveable into and out of the molding cavity 40 to exert force against the coating and fiber.

It may be desirable to proof test the integrity of the optical splice to ensure that defective splices are identified early in the assembly process of an optical circuit. Consequently, the recoater may be provided with a fiber tension tester that subjects the recoated optical splice to a predetermined amount of axial tension. Failure of the optical splice under axial tension may be indicative of a defective splice between the pair of optical fibers.

In one illustrative embodiment shown in FIG. 1, the tension tester includes a pair of tension clamps 60 and 64 that are configured to grip opposing end portions of the recoated fiber. Each clamp 60 and 64 is supported for movement in an axial direction along the molding axis 24. One clamp 60 is coupled to a drive mechanism 62 that may be actuated to move the clamp 60 toward and away from one end of the mold 34. The second clamp 64 is coupled to a tension monitor, such as a load cell 66, that restricts movement of the clamp 64 relative to the second end of the mold 34.

When it is desired to proof test the fiber 35, the first clamp 60 is driven away from the first end of the mold 34 while gripping the end portion of the fiber 35. Since movement of the second clamp 64 is restricted by the tension monitor, the fiber 35 becomes subjected to an axial tension that increases as the first clamp 60 is driven away from the mold 34 and the second clamp 64. Once a predetermined amount of axial tension, as measured by the tension monitor, is placed on the fiber 35 and is held for a predetermined amount of time according to a predetermined tension test program, the first clamp 60 is moved back toward the mold 34 to relieve the fiber 35 of the axial tension. The tension clamps 60 and 64 are subsequently opened to release the fiber 35 from the recoater 20.

While one embodiment of a tension tester has been disclosed, the invention is not limited in this respect. It is to be understood that other tension tester arrangements may be implemented with the recoater 20. For example, the recoater 20 may employ a capstan arrangement in which the fiber 35 is wrapped about a pair of spools that are slowly pulled away from each other to apply tension to the optical fiber 35.

One illustrative embodiment of a method of automatically recoating a portion of an optical fiber will now be described in conjunction with the recoater 20 described above. More particularly, the illustrative method is directed to recoating an optical fiber splice.

The automated recoating process begins with placement of the spliced optical fiber 35 in close proximity to the molding axis 24. Once the fiber 35 is in place, the recoater 20 is moved into position relative to the molding axis 24. In response to a signal from a controller 68, the fiber supports 32 close about and accurately position the fiber 35 along the molding axis 24 with the splice located between the pair of fiber supports 32. With the fiber 35 properly located on the molding axis 24, the recoat mold 34 is closed about the fiber splice. Coating material is subsequently injected into the mold 34 to surround the fiber portion enclosed therein.

Once the desired amount of coating material is delivered to the mold 34, the light shutter 52 is opened to expose the mold to UV light for curing the coating material. The light guide 48 is scanned along the length of the mold 34 to progressively expose and cure the coating material. Once the light scan is complete, the light shutter 52 is closed to prevent further exposure of the mold 34 to the light source 50.

Upon completion of the curing sequence, the air ejector 54 is actuated to deliver a pulse of pressurized air to the mold 34 so as to dislodge the protective coating from the mold 34. The recoat mold 34 is subsequently opened whereupon the tension tester clamps 60 and 64 are closed to grasp end portions of the optical fiber 35. Once clamped, the fiber supports 32 are opened to release the fiber 35.

The fiber 35 is then subjected to a proof test by applying an axial tension to the fiber 35 through relative movement of the tension clamps 60 and 64 in an axial direction. The proof test is conducted in accordance with a predetermined tension profile program. Upon completion of the proof test, the tension clamps 60 and 64 are opened to release the optical fiber 35 from the recoater 20. The recoater 20 is subsequently moved away from the fiber 35 so that the recoated fiber may be moved to the next manufacturing process.

The automated method of recoating an optical fiber may include any one of the foregoing process steps, a combination of two or more of the foregoing process steps, or all of the foregoing process steps. It is to be appreciated that the sequence in which the method has been described may be carried out in any desired manner.

The optical fiber recoater 20 may be arranged to automatically respond to signals from a controller 68 configured to govern the actions of the recoater 20 and instruct the various components of the recoater 20 to actuate in response to confirmation signals from one or more sensors that a particular action has occurred. Of course, some of the operations may optionally include manual interaction for the performance of certain steps or processes.

The controller 68 may be arranged to transmit and receive signals to and from various components to control the various operations of the fiber recoater 20. The controller 68 may be arranged to communicate with the various components by direct hard link, wireless communication, and other suitable arrangements. The controller 68 may receive a signal that a particular step has begun or ended and the controller 68 may, in response to such a signal, generate a new signal initiating one or more operations of the components.

The controller 68 may be implemented in any of numerous ways, as the present invention is not limited to any particular technique. In accordance with one illustrative embodiment of the present invention, the controller 68 is a processor that is programmed (via software) to perform the above-recited control functions, and to coordinate interaction among the various system components. Of course, it should be appreciated that other implementations are possible, including the use of a hardware controller, and/or multiple controllers that replace a single central controller. As an example, and without limiting the invention, the controller 68 may include a Windows NT based PC, and a distributed I/O system using a field bus such as a CANOpen.

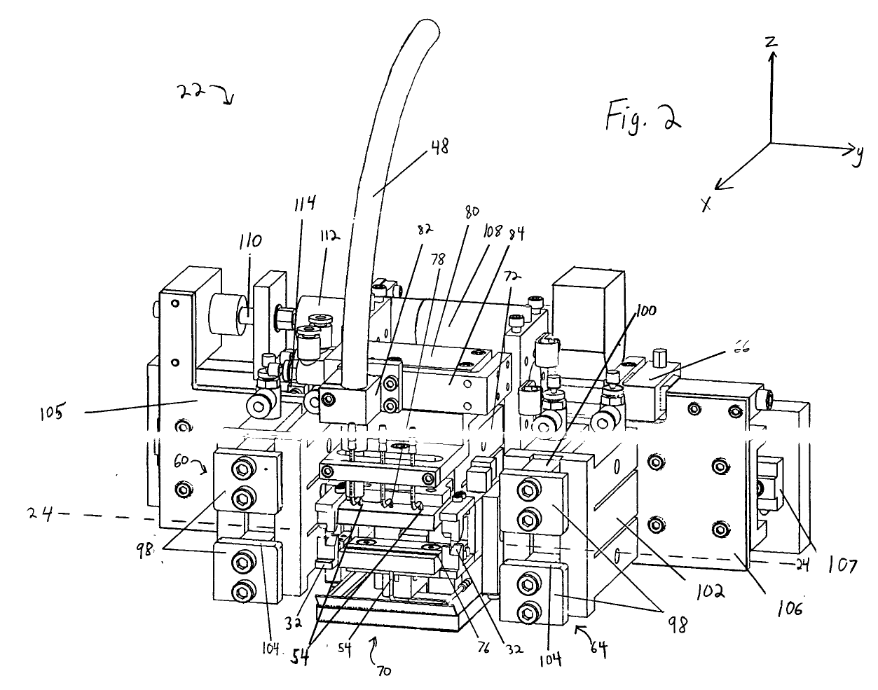

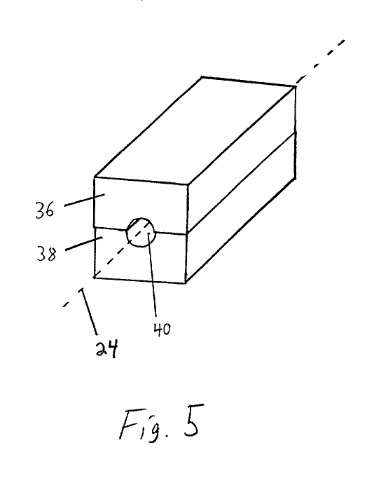

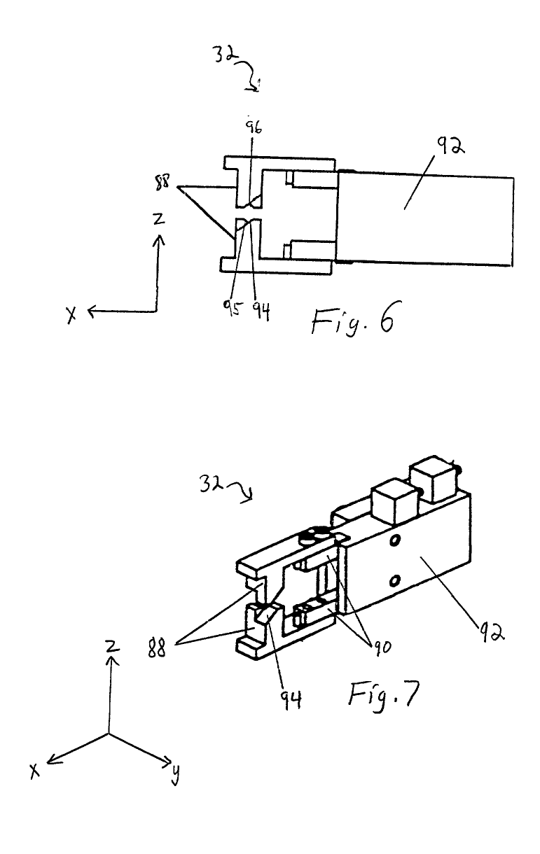

Although the optical fiber recoater 20 is not intended to be limited to any particular configuration, one illustrative embodiment of a recoater is shown in FIGS. 2-8. It is to be understood that the following detailed description is merely exemplary and it is contemplated that other recoater configurations may be implemented for recoating an optical fiber.

In one illustrative embodiment shown in FIGS. 2-4, the optical fiber recoater 20 includes a recoater module 22 that may be positioned relative to a predetermined molding axis 24. As illustrated, the recoater module 22 includes a mold assembly 70 that is configured to mold a protective coating about a desired portion of an optical fiber, such as a fiber splice. A pair of fiber supports 32 are provided at opposing ends of the mold assembly to maintain an optical fiber along the molding axis 24 during the recoating process. The recoater module 22 may also include a tension tester configured to proof test the integrity of the optical fiber splice.

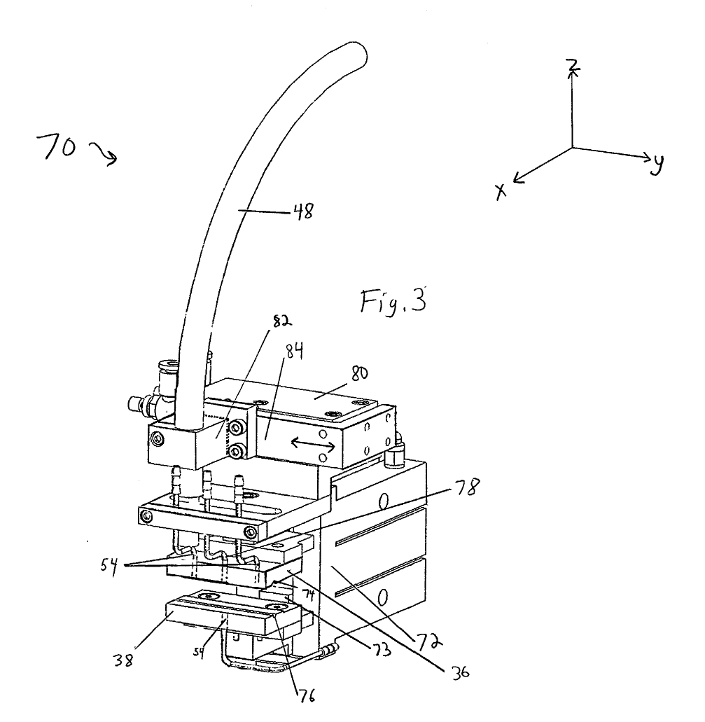

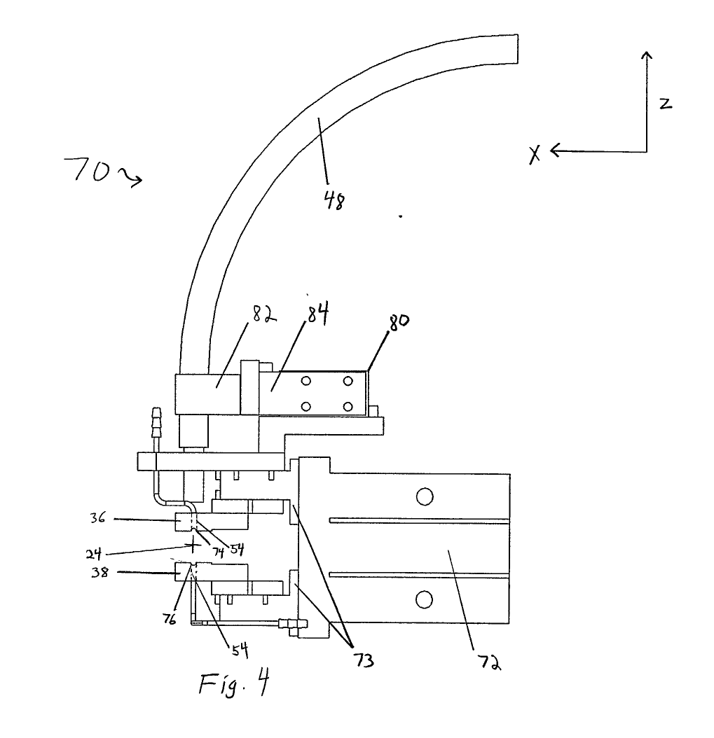

In one illustrative embodiment shown in FIGS. 3-4, the mold assembly 70 includes a mold 34 comprised of a first or upper mold 36 and a second or lower mold 38 that are movable toward and away from each other and the molding axis 24 between open and closed positions. The upper and lower molds 36 and 38 are coupled to a drive mechanism that is configured to open and close the mold in response to a signal from the controller. In one embodiment, the upper and lower molds 36 and 38 are coupled to a pneumatic cylinder 72 that includes a slide bearing 73 along which ride the molds 36 and 38. It is to be understood, however, that the mold assembly 70 may employ any suitable drive mechanism to open and close the mold 34 and the present invention is not limited to the illustrative embodiment. Additionally, the mold assembly 70 may be configured so that only one of the upper and lower molds 36 and 38 is moved to open and close the mold 34.

The upper and lower molds 36 and 38 are configured to form a mold cavity 40 about the molding axis 24 and any fiber along the molding axis 24 when the mold 34 is actuated to the closed position. In one illustrative embodiment, the upper and lower molds 36 and 38 each include an elongated groove or recess 74 and 76 that extend along the length of the mold 34 in a direction parallel to the molding axis 24. In the closed position, the opposing grooves 74 and 76 cooperate to form the mold cavity 40 about the molding axis 24. The mold cavity 40 is configured to have a length that is at least equal to, but preferably exceeds, the length of the exposed fiber to ensure complete coverage of the exposed portion of the fiber.

In one embodiment, each groove 74 and 76 is configured with a semi-cylindrical shape that results in a mold cavity 40 having a generally cylindrical shape. When the mold 34 is closed, the mold cavity 40 is positioned coaxial with the molding axis 24 to provide uniform clearance between the mold 34 and the optical fiber located on the molding axis 24. It is to be appreciated that the mold cavity 40 is not limited to a cylindrical shape that is to be positioned coaxial with the molding axis 24. Rather, the mold cavity 40 may be configured to have any desirable shape and any desirable position relative to the molding axis 24.

As indicated above, the mold 34 may be configured to accommodate optical fibers having any of a plurality of fiber diameters to enhance the utility of the recoater. In one embodiment, the mold cavity 40 has a diameter of approximately 2 mm to accommodate fiber diameters ranging from approximately 180 microns to approximately 900 microns. The mold cavity 40 also has a length of approximately 32 mm. As is to be appreciated, the mold cavity 40 may be configured to have any size suitable for accommodating any range of fibers. For example, it is contemplated that the mold cavity 40 may be sized to have a diameter that ranges from approximately 0.1 mm to approximately 6 mm.

To enhance its utility for molding a protective coating about fibers of various diameters, the mold 34 may be configured as a seal-less mold. In one illustrative embodiment, at least the opposing ends of the mold cavity 40 remain open and are not otherwise sealed in the axial direction so that an annular gap is formed between the fiber and the mold 34. Coating material delivered to the mold cavity 40 is maintained within the cavity at least by way of surface tension between the material and the mold 34. Any of a number of factors, either individually or combined, may influence the ability of the seal-less mold to prevent leakage of the coating material. For example, such factors may include, but are not limited to, the relative size of the mold cavity 40 to the fiber, the amount of material relative to the mold volume, the pressure of the coating material delivered to the mold 34 and the viscosity of the coating material.

The mold 34 may include one or more ports or inlets that are fluidly coupled to the mold cavity 40 for feeding coating material from a supply or reservoir 42 to the mold cavity 40. In one illustrative embodiment, a single inlet port 78 is provided on the upper mold 36 and in direct communication with the upper groove 74. The port 78 is configured to be connected to the reservoir 42 with any suitable hose or conduit 44. The port 78 is centrally located relative to the mold cavity 40 so that coating material may be uniformly distributed throughout the cavity 40. It is to be appreciated, however, that the mold 34 is not limited to a single inlet port and that any number of ports may be employed on one or both of the upper and lower molds 36 and 38 to deliver coating material to the mold cavity 40. Additionally, coating material may be fed to the mold cavity 40 from any location on the mold 34.

As discussed above in connection with FIG. 1, the mold 34 is to be connected to a material reservoir 42 maintained at a substantially constant pressure so that when the fluid dispense valve 46 opens, coating material is fed through the inlet port and into the mold cavity 40. By opening the fluid dispense valve 46 for a predetermined amount of time while maintaining the reservoir 42 at a known pressure, a desired amount of coating material is injected into the mold cavity 40. The amount of coating material injected into the mold cavity 40 may be adjusted, for example, by controlling the pressure of the reservoir 42, the length of time that the valve 46 remains open, the viscosity of the coating material, or any combination of these factors. As should be appreciated, the recoater 20 may employ any suitable arrangement for feeding coating material into the mold 34. For example, a positive displacement system may be used to drive coating material into the mold 34.

The recoater 20 may be configured to utilize any coating material suitable for recoating optical fiber. In one illustrative embodiment, the recoater 20 employs a UV light curable polymer as the coating material. One example of a suitable UV-curable polymer for recoating an optical fiber is product no. DSM 950-200 available from DSM Desotech, Inc. It is to be understood that the recoater 20 is not limited to a particular coating material as any suitable coating material may be used to form a protective coating on a length of optical fiber with the recoater 20.

As discussed above, it may be desirable to accelerate curing of the coating material about the optical fiber to reduce the cycle time of the recoating process. In one illustrative embodiment shown in FIGS. 2-4, the mold assembly includes a light guide 48 that is configured to be coupled to a light source 50. The light guide 48 is supported above the upper mold 36 to emit light from the light source 50 onto the mold. In this regard, the mold 34 may be formed from a transparent or translucent material that allows the emitted light to pass therethrough so that coating material within the mold cavity 40 may be exposed to and cured by the emitted light. In one embodiment, the mold 34 is formed from quartz, although any suitable material may be used, such as an acrylic or polycarbonate.

To enhance the integrity of the protective coating, it may be desirable to progressively cure the coating material within the mold cavity 40. In one illustrative embodiment, the light guide 48 is coupled to a drive mechanism that sweeps the light guide 48 along the length of the mold 34. The light guide 48 is configured to expose only a limited portion of the mold cavity 40 in close proximity to the guide 48 so that progressive curing of the coating material is achieved by movement of the guide along the length of the mold 34.

In the illustrative embodiment, the light guide 48 is mounted to a pneumatic slide actuator 80 using a mount block 82 that is connected to the slide portion 84 of the actuator 80. In response to actuation signals from the controller 68, the actuator 80 extends and retracts the slide 84 to sweep the light guide 48 along the length of the mold 34. The slide actuator 80 itself is coupled to the mold drive mechanism so that the light guide 48 is raised and lowered in conjunction with the upper mold 36 so that the guide 48 may be maintained in close proximity to the mold 34. It is to be understood that any suitable drive mechanism may be implemented to sweep the guide 48 along the mold 34. It is also contemplated that progressive curing may be achieved by moving the mold 34 relative to the light guide 48, or moving both the light guide 48 and the mold 34 relative to each other.

In one embodiment, the light guide 48 is swept along substantially the full length of the mold 34 in one direction and then back along the mold 34 in the opposite direction while the light shutter 52 is open to cure the coating material with the emitted light. It is contemplated that one pass or more than two passes of the light guide 48 may be implemented to cure the coating material within the mold cavity 40. It is also contemplated that multiple light guides 48 or emitters, either stationary or movable, may be used to cure the coating material. It is further contemplated that the light guide 48 or emitter may be rotated relative to the mold 34. Rather than employing a remote light source 50 with a light guide 48 as described, the recoater 20 may incorporate a light source 50 therein.

As described above in connection with FIG. 1, the recoater 20 may employ a shuttered light source in which the light source 50 remains continuously illuminated and emission of light onto the mold 34 from the light guide 48 is controlled with a shutter 52 located at the light source 50 or between the light source 50 and the mold. In one embodiment, the recoater 20 may utilize any of a number of shuttered light sources available from EFOS Inc., including the EFOS Lite and Acticure systems. Of course, the recoater 20 is not limited to any particular shuttered light source, as any suitable light source 50 arrangement may be employed to cure the coating material.

The recoater module 22 may include an ejector arrangement that is configured to dislodge any cured coating material that becomes adhered to the mold during the recoating process. In one illustrative embodiment, the mold assembly 70 employs an air ejector arrangement that is configured to deliver a pulse of pressurized air to the molding cavity 40. As illustrated, a plurality of air ejectors 54 are provided on the upper and lower molds 36 and 38 to be in fluid communication with the respective upper and lower grooves 74 and 76 of the molds 36 and 38. The ejectors 54 are configured to be coupled to a pressurized air source 58 using hoses or other suitable fluid connections 86.

A pulse of pressurized air is delivered to the mold cavity 40 through the ejectors 54 in response to an actuation signal from the controller 68 to an air valve 56 located between the pressure source 58 and the ejectors 54. When the curing process has been completed, the air valve 86 is instructed to open and the flow of air through the ejectors 54 exerts pressure against the recoated portion of the fiber 35 to dislodge from the mold 34 any portion of the cured coating and fiber 35 that may have become adhered to the mold 34 during the molding sequence. Once the ejection sequence has been completed, the mold 34 may be opened to allow removal of the recoated fiber.

Although the illustrative embodiment includes three ejectors 54 including a pair of ejectors 54 on the upper mold 36 and a single ejector 54 on the lower mold 38, any number and combination of ejectors 54 may be employed to facilitate removal of the recoated fiber from the mold 34. It is also contemplated that the recoater 20 may utilize other arrangements for ejecting the fiber 35 from the mold 34. For example, and without limiting the present invention, the mold 34 may employ one or more ejector pins that are moveable into and out of the mold cavity 40 to exert a force against the recoated fiber to dislodge the fiber 35 from the mold.

As indicated above, the fiber supports 32 are configured to grasp and position, along the molding axis 24, an optical fiber having any of a plurality of diameters. Each fiber support 32 may be configured as a centralizing clamp that captures and positions the fiber along the molding axis 24 regardless of the fiber diameter and its location within a region of uncertainty about the mounting axis. In doing so, the position of the mold may not need to be adjusted or altered to accommodate fibers of various diameters.

In one illustrative embodiment shown in FIGS. 2-4 and FIGS. 6-7, each fiber support 32 includes a pair of clamping jaws 88 that are moveable between an open position for receiving and releasing an optical fiber and a closed position for capturing and centralizing the fiber along the mounting axis 24. The clamp jaws are coupled to an actuator for movement between the open and closed positions in response to a signal from the controller. In one embodiment, the clamp jaws are mounted to the slide bearing 90 of a pneumatic air cylinder 92. It is contemplated that other suitable arrangements may be implemented for actuating the clamp jaws 88, for example, coupling the clamp jaws 88 to a solenoid or an electric motor.

In the illustrative embodiment, each clamp jaw 88 includes a pair of angled clamp surfaces 94 and 95 that provide a centralizing zone midway between the ends of the jaws 88. The angled clamp surfaces 94 and 95 form a generally V-shaped notch 96 configured to cooperate with the corresponding notch of the opposed jaw to capture and position the fiber 35 along the molding axis 24. It is to be appreciated that other jaw configurations may be employed to position and grip the fiber 35 on the molding axis 24.

As discussed above, the recoater 20 may include a tension tester to proof test the integrity of the spliced optical fiber. In one illustrative embodiment shown in FIG. 2, the tension tester includes first and second tension clamps 60 and 64 that are configured to grip opposing end portions of the fiber and exert a predetermined axial force on the fiber in accordance with a tension test program. The tension clamps 60 and 64 are movably supported adjacent the opposing ends of the mold 34 so that the clamps may be moved relative to each other in a direction parallel to the molding axis 24 to place the fiber 35 under axial tension.

Each of the tension clamps 60 and 64 includes a pair of clamp jaws 98 that are moveable between open and closed to positions to grip and release the fiber. The clamp jaws 98 are coupled to an actuator that opens and closes the jaws 98 in response to a signal from the controller 68. In one embodiment, the clamp jaws 98 are mounted to the slide bearing 100 of a pneumatic air cylinder 102. It is to be understood that the illustrated tension clamps 98 are merely exemplary and that the tension tester may employ any suitable tension clamp configuration.

The tension clamps 60 and 64 include opposed flat clamping surfaces 104 for gripping the optical fiber 35 in a manner that avoids point loads on the fiber 35 by distributing clamping loads over a relatively large length of fiber. The flat clamping surfaces 104 may also accommodate some misalignment of the fiber 35 with the clamps 60 and 64. The lack of a V-groove or other gripping shape on the clamping surfaces 104 may reduce the need for providing some amount of fiber slack for gripping the fiber with shaped clamping surfaces. It is to be appreciated, however, that the clamp jaws 98 may be configured to have any desirable clamping surface configuration, such as curved or other non-planar surfaces.

The tension clamps 60 and 64 are movably supported independent of each other so that the distance between the clamps 60 and 64 may be increased or decreased to vary the amount of axial tension placed on the fiber 35. In one illustrative embodiment, each tension clamp 60 and 64 is slidably mounted adjacent an end of the mold 34 with a mounting plate 105 and 106 that is mounted to a slide bearing 107. The mounting arrangement allows each tension clamp 60 and 64 to be slid toward and away from the mold 34 in a direction parallel to the molding axis 24. The first tension clamp 60 is coupled to a drive mechanism that operates to move the first tension clamp 60 toward and away from the mold 34, while the second tension clamp 64 is coupled to a restraint that resists movement of the second clamp 64 so as to place the fiber under axial tension as the first tension clamp 60 is driven in a direction away from the second tension clamp 64.

In one illustrative embodiment shown in FIG. 2, the drive mechanism for the first tension clamp 60 includes a servomotor 108 which rotates a lead screw 110 that is coupled to the clamp mounting plate 105. A coupler 112 may be employed to accommodate misalignment between the servomotor 108 and the lead screw 110. The servomotor 108 may be actuated to move the first tension clamp 60 in response to a control signal from the controller 68. Sensors, such as optical sensors 114, may be employed to indicate over-travel of the first tension clamp 60 relative to the mold 34, such as when the optical fiber 35 fails the proof test.

As indicated above, the second tension clamp 64 is coupled to a restraint which resists movement of the clamp 64 to place the fiber 35 under axial tension. In one illustrative embodiment, the restraint includes a tension monitor, such as a load cell 66, that is configured to inform the controller 68 as to the amount of force or tension being exerted on the fiber 35. As illustrated, the load cell 66 is coupled to the mounting plate 106 for the clamp 64.

The illustrative embodiment of the tension tester is shown by way of example. It is to be appreciated that other methods of applying, controlling, and measuring axial tension on the fiber 35 may be used. For example, a capstan system including a pair of spools to hold the fiber 35 may be used to apply tension to the fiber.

It may be desirable to couple the recoater module 22 to one or more drive mechanisms that are configured to move the recoater module 22 in one or more directions relative to the molding axis 24. This may be particularly advantageous when incorporating the recoater 20 in an automated manufacturing system.

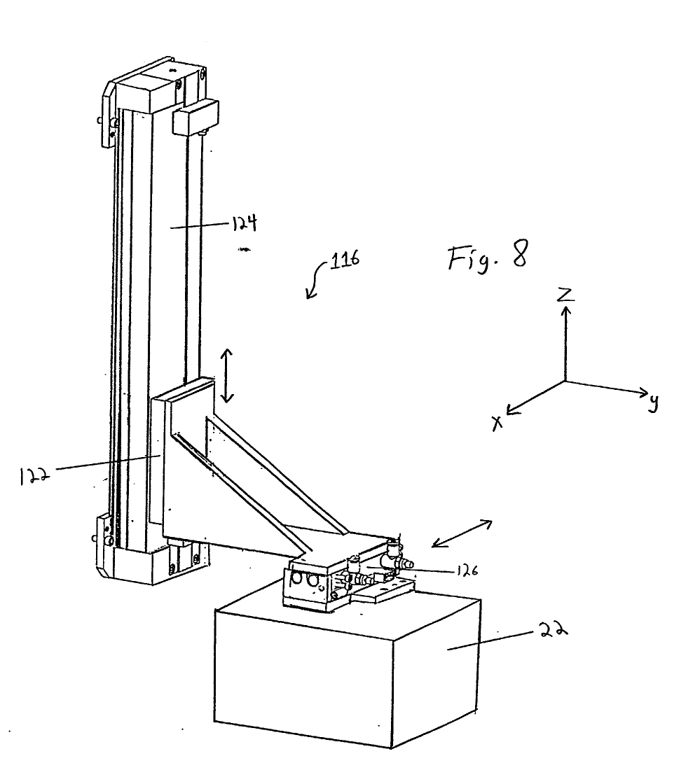

In one illustrative embodiment shown in FIG. 8, the recoater module 22 may be supported on a gantry-like system 116 configured to move the fiber recoater module 22 toward and away from a fiber 35 in one or more directions, as desired. The gantry system may include horizontal and vertical drive mechanisms, such as pneumatic actuator assemblies, to move the recoater module 22 vertically (Z-direction) and horizontally in a direction perpendicular to the molding axis 24 (X-direction). As illustrated, the vertical drive includes a carriage 122 that is moveable linearly along a slide bearing 124. The horizontal drive is coupled to the carriage of the vertical drive and includes a pneumatic slide actuator 126 to which is mounted the recoater module 22. As is to be appreciated, other arrangements may be employed for moving the recoater module 22 in any desired direction or combination of directions, including both linear and rotational movement.

The various components of the fiber recoater module 22 and the gantry system 116 may be mounted to a frame (not shown) which may house various electronics, pneumatic controls and connections for operating the recoater, including a dedicated controller, displays, input devices and the like, if desired. As an example, and without restricting the control features that may be employed with the optical fiber recoater 20, one or more sensors may be provided to detect the location of a fiber or operational status of a recoater component. In response to a signal generated by the sensor, the controller may cause one or more components of the recoater to perform a desired function.

Having described several illustrative embodiments of the invention in detail, various modifications and improvements will readily occur to those skilled in the art. Such modifications and improvements are intended to be within the scope of the invention. Accordingly, the foregoing description is by way of example only and is not intended as limiting. The invention is limited only as defined by the following claims and the equivalents thereto.

What is claimed is:

1. An optical fiber recoater, comprising:
a mold having a mold cavity adapted to enclose a length of optical fiber along a molding axis, the mold being adapted to receive a light curable coating material in the molding cavity 40 to form a protective coating on the length of optical fiber, the mold being constructed and arranged to pass light through the molding cavity to expose and cure the coating material; and
a light guide supported adjacent the mold, the light guide being constructed and arranged to emit a light beam onto at least first and second portions of the mold to expose and cure at least first and second portions of the coating material in the molding cavity with the light beam,
at least one of the mold and the light guide being movable relative to the other of the mold and the light guide to expose the at least first and second portions of the mold, respectively, at a first time and at a second time that is different from the first time to progressively cure the at least first and second portions of the coating material at the first and second times to form the protective coating.

2. The optical fiber recoater according to claim 1, wherein the light guide is movably supported relative to the mold.

3. The optical fiber recoater according to claim 2, wherein the light guide is movable in a direction along the molding axis.

4. The optical fiber recoater according to claim 3, wherein the light guide is configured to continuously sweep along the mold.

5. The optical fiber recoater according to claim 2, wherein the light guide is movable in response to a control signal.

6. The optical fiber recoater according to claim 1, further comprising first and second fiber supports disposed adjacent first and second ends of the mold, the first and second fiber supports being constructed and arranged to support the length of optical fiber along the molding axis.

7. The optical fiber recoater according to claim 6, wherein the first and second fiber supports are configured to open and close about the length of optical fiber in response to a control signal.

8. The optical fiber recoater according to claim 6, wherein each of the first and second fiber support includes a centralizing clamp that is constructed and arranged to position each of a plurality of optical fibers coaxial with the molding axis, each of the plurality of optical fibers having an outer diameter that differs from an outer diameter of others of the plurality of optical fibers.

9. The optical fiber recoater according to claim 1, further comprising a tension tester constructed and arranged to induce a predetermined amount of axial tension on the length of optical fiber.

10. The optical fiber recoater according to claim 9, wherein the tension tester is configured to induce the predetermined amount of axial tension in response to a control signal.

11. The optical fiber recoater according to claim 1, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

12. The optical fiber recoater according to claim 11, wherein the first and second molds are moveable in response to a control signal.

13. The optical fiber recoater according to claim 1, further comprising an ejector coupled to the mold, the ejector being constructed and arranged to dislodge the protective coating from the mold in response to a control signal.

14. A method of recoating a length of optical fiber, the method comprising:
(a) enclosing the length of optical fiber within a molding cavity of a mold along a molding axis;
(b) dispensing a coating material into the molding cavity to form a protective coating on the length of optical fiber;
(c) exposing a first portion of the mold with a light beam to cure a first portion of the coating material;
(d) moving at least one of the mold and the light beam relative to the other of the mold and the light beam; and
(e) exposing a second portion of the mold with the light beam to cure a second portion of the coating material to form the protective coating.

15. The method according to claim 14, wherein step (d) includes moving the light beam from the first portion of the mold to the second portion of the mold.

16. The method according to claim 15, wherein step (d) includes moving the light beam in response to a control signal.

17. The method according to claim 14, wherein step (d) includes moving the light beam along the molding axis from a first end of the mold to a second end of the mold to cure the coating material within the molding cavity.

18. The method according to claim 17, wherein step (d) includes moving the light beam in a continuous motion.

19. The method according to claim 14, further comprising exerting a force on the protective coating within the molding cavity to separate the protective coating from the mold subsequent to step (e) in response to a control signal.

20. The method according to claim 14, further comprising applying a predetermined amount of axial tension on the length of optical fiber subsequent to step (e) in response to a control signal.

21. An optical fiber recoater, comprising:
a mold having a mold cavity adapted to enclose a length of optical fiber along a molding axis, the mold being adapted to receive a coating material in the molding cavity to form a protective coating on the length of optical fiber; and
an ejector coupled to the mold, the ejector being constructed and arranged to dislodge the protective coating from the mold in response to a control signal.

22. The optical fiber recoater according to claim 21, wherein the ejector includes at least one air inlet port fluidly coupled to the molding cavity, the at least one air inlet port constructed and arranged to be coupled to an air source.

23. The optical fiber recoater according to claim 22, wherein the at least one air inlet port includes a plurality of air inlet ports disposed on the mold.

24. The optical fiber recoater according to claim 23, wherein the plurality of air inlet ports are spaced apart along the molding axis.

25. The optical fiber recoater according to claim 21, further comprising a light guide supported adjacent the mold, the light guide being constructed and arranged to emit a light beam onto the mold to expose and cure the coating material in the molding cavity with the light beam.

26. The optical fiber recoater according to claim 25, wherein the light guide is movable relative to the mold to progressively cure the coating material.

27. The optical fiber recoater according to claim 26, wherein the light guide is movable in response to a control signal.

28. The optical fiber recoater according to claim 21, further comprising first and second fiber supports disposed adjacent first and second ends of the mold, the first and second fiber supports being constructed and arranged to support the length of optical fiber along the molding axis.

29. The optical fiber recoater according to claim 28, wherein the first and second fiber supports are configured to open and close about the length of optical fiber in response to a control signal.

30. The optical fiber recoater according to claim 28, wherein each of the first and second fiber supports includes a centralizing clamp that is constructed and arranged to position each of a plurality of optical fibers coaxial with the molding axis, each of the plurality of optical fibers having an outer diameter that differs from an outer diameter of others of the plurality of optical fibers.

31. The optical fiber recoater according to claim 21, further comprising a tension tester constructed and arranged to induce a predetermined amount of axial tension on the length of optical fiber.

32. The optical fiber recoater according to claim 31, wherein the tension tester is configured to induce the predetermined amount of axial tension in response to a control signal.

33. The optical fiber recoater according to claim 21, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

34. The optical fiber recoater according to claim 33, wherein the first and second molds are moveable in response to a control signal.

35. A method of recoating a length of optical fiber, the method comprising:
(a) enclosing the length of optical fiber within a molding cavity of a mold;
(b) dispensing a coating material into the molding cavity;
(c) curing the coating material to form a protective coating on the length of optical fiber; and
(d) exerting a force on the protective coating within the molding cavity to separate the protective coating from the mold in response to a control signal.

36. The method according to claim 35, wherein step (d) includes injecting air into the molding cavity.

37. The method according to claim 36, wherein step (d) includes injecting air at a plurality of inlet ports.

38. The method according to claim 35, wherein step (c) includes moving a light beam along the mold to progressively cure the coating material.

39. The method according to claim 38, wherein step (c) includes moving the light beam in response to a control signal.

40. The method according to claim 35, further comprising applying a predetermined amount of axial tension on the length of optical fiber subsequent to step (d) in response to a control signal.

41. An optical fiber recoater, comprising:
a mold having a mold cavity adapted to enclose a length of optical fiber along a molding axis, the mold being adapted to receive a light curable coating material in the molding cavity to form a protective coating on the length of optical fiber, the mold being constructed and arranged to pass light through the molding cavity to expose and cure the coating material; and
a shuttered light source constructed and arranged to emit a light beam onto the mold to expose and cure the coating material in the molding cavity with the light beam, the shuttered light source including a light shutter that is operable between open and closed positions in response to a control signal to selectively expose the mold with the light beam when the light shutter is in the open position.

42. The optical fiber recoater according to claim 41, wherein the shuttered light source includes a light guide supported adjacent the mold, the light guide being constructed and arranged to emit the light beam onto the mold.

43. The optical fiber recoater according to claim 42, wherein the light guide is movable relative to the mold to progressively cure the coating material.

44. The optical fiber recoater according to claim 43, wherein the light guide is movable in response to a control signal.

45. The optical fiber recoater according to claim 41, further comprising first and second fiber supports disposed adjacent first and second ends of the mold, the first and second fiber supports being constructed and arranged to support the length of optical fiber along the molding axis.

46. The optical fiber recoater according to claim 45, wherein the first and second fiber supports are configured to open and close about the length of optical fiber in response to a control signal.

47. The optical fiber recoater according to claim 46, wherein each of the first and second fiber supports includes a centralizing clamp that is constructed and arranged to position each of a plurality of optical fibers coaxial with the molding axis, each of the plurality of optical fibers having an outer diameter that differs from an outer diameter of others of the plurality of optical fibers.

48. The optical fiber recoater according to claim 41, further comprising a tension tester constructed and arranged to induce a predetermined amount of axial tension on the length of optical fiber.

49. The optical fiber recoater according to claim 48, wherein the tension tester is configured to induce the predetermined amount of axial tension in response to a control signal.

50. The optical fiber recoater according to claim 41, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

51. The optical fiber recoater according to claim 50, wherein the first and second molds are moveable in response to a control signal.

52. An optical fiber recoater, comprising:
a mold having a mold cavity adapted to individually enclose each of a plurality of optical fibers along a molding axis, each of the plurality of optical fibers having an outer diameter that differs from an outer diameter of others of the plurality of optical fibers, the mold being adapted to receive a coating material in the molding cavity to form a protective coating on a length of each of the plurality of optical fibers; and
first and second fiber supports that are disposed adjacent first and second ends of the mold, the first and second fiber supports being constructed and arranged to support the length of each of the plurality of optical fibers along the molding axis.

53. The optical fiber recoater according to claim 52, wherein the molding cavity has a diameter that is greater than the outer diameter of each of the plurality of optical fibers.

54. The optical fiber recoater according to claim 53, wherein the mold includes first and second ends spaced apart along the molding axis, the molding cavity extending to and through the first and second ends of the mold.

55. The optical fiber recoater according to claim 53, wherein the mold cavity is free of a seal from the first end to the second end of the mold along the molding axis.

56. The optical fiber recoater according to claim 52, further comprising a light guide supported adjacent the mold, the light guide being constructed and arranged to emit a light beam onto the mold to expose and cure the coating material in the molding cavity with the light beam.

57. The optical fiber recoater according to claim 56, wherein the light guide is movable relative to the mold to progressively cure the coating material.

58. The optical fiber recoater according to claim 57, wherein the light guide is movable in response to a control signal.

59. The optical fiber recoater according to claim 52, wherein the first and second fiber supports are configured to open and close about each of the plurality of optical fibers in response to a control signal.

60. The optical fiber recoater according to claim 59, wherein each of the first and second fiber support includes a centralizing clamp that is constructed and arranged to position each of a plurality of optical fibers coaxial with the molding axis, each of the plurality of optical fibers having an outer diameter that differs from an outer diameter of others of the plurality of optical fibers.

61. The optical fiber recoater according to claim 52, further comprising a tension tester constructed and arranged to induce a predetermined amount of axial tension on the length of optical fiber.

62. The optical fiber recoater according to claim 61, wherein the tension tester is configured to induce the predetermined amount of axial tension in response to a control signal.

63. The optical fiber recoater according to claim 52, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

64. The optical fiber recoater according to claim 63, wherein the first and second molds are moveable in response to a control signal.

65. An optical fiber recoater, comprising:
a mold having a mold cavity adapted to enclose a length of optical fiber along a molding axis, the mold being adapted to receive a coating material in the molding cavity to form a protective coating on the length of optical fiber, the mold including first and second ends spaced apart along the molding axis, the molding cavity extending to and through the
first and second ends of the mold, the mold cavity being free of a seal from the first end to the second end of the mold along the molding axis; and
first and second fiber supports that are disposed adjacent the first and second ends of the mold, the first and second fiber supports being constructed and arranged to support the length of optical fiber along the molding axis.

66. The optical fiber recoater according to claim 65, further comprising a light guide supported adjacent the mold, the light guide being constructed and arranged to emit a light beam onto the mold to expose and cure the coating material in the molding cavity with the light beam.

67. The optical fiber recoater according to claim 66, wherein the light guide is movable relative to the mold to progressively cure the coating material.

68. The optical fiber recoater according to claim 67, wherein the light guide is movable in response to a control signal.

69. The optical fiber recoater according to claim 65, wherein the first and second fiber supports are configured to open and close about the length of optical fiber in response to a control signal.

70. The optical fiber recoater according to claim 69, wherein each of the first and second fiber supports includes a centralizing clamp that is constructed and arranged to position each of a plurality of optical fibers coaxial with the molding axis, each of the plurality of optical fibers having an outer diameter that differs from an outer diameter of others of the plurality of optical fibers.

71. The optical fiber recoater according to claim 65, further comprising a tension tester constructed and arranged to induce a predetermined amount of axial tension on the length of optical fiber.

72. The optical fiber recoater according to claim 71, wherein the tension tester is configured to induce the predetermined amount of axial tension in response to a control signal.

73. The optical fiber recoater according to claim 65, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

74. The optical fiber recoater according to claim 73, wherein the first and second molds are moveable in response to a control signal.

75. An optical fiber recoater, comprising:
a mold having a mold cavity adapted to enclose a length of optical fiber along a molding axis, the mold being adapted to receive a coating material in the molding cavity to form a protective coating on the length of optical fiber, the mold including a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity; and
first and second fiber supports that are disposed adjacent first and second ends of the mold, the first and second fiber supports being constructed and arranged to support the length of optical fiber along the molding axis as the first and second molds are moved toward and away from the molding axis.

76. The optical fiber recoater according to claim 75, further comprising a light guide supported adjacent the mold, the light guide being constructed and arranged to emit a light beam onto the mold to expose and cure the coating material in the molding cavity with the light beam.

77. The optical fiber recoater according to claim 76, wherein the light guide is movable relative to the mold to progressively cure the coating material.

78. The optical fiber recoater according to claim 77, wherein the light guide is movable in response to a control signal.

79. The optical fiber recoater according to claim 75, wherein the first and second fiber supports are configured to open and close about the length of optical fiber in response to a control signal.

80. The optical fiber recoater according to claim 79, wherein each of the first and second fiber supports includes a centralizing clamp that is constructed and arranged to position each of a plurality of optical fibers coaxial with the molding axis, each of the plurality of optical fibers having an outer diameter that differs from an outer diameter of others of the plurality of optical fibers.

81. The optical fiber recoater according to claim 75, further comprising a tension tester constructed and arranged to induce a predetermined amount of axial tension on the length of optical fiber.

82. The optical fiber recoater according to claim 81, wherein the tension tester is configured to induce the predetermined amount of axial tension in response to a control signal.

83. The optical fiber recoater according to claim 75, wherein the first and second molds are moveable in response to a control signal.

84. An optical fiber recoater, comprising:
a mold having a mold cavity adapted to enclose a length of optical fiber along a molding axis, the mold being adapted to receive a coating material in the molding cavity to form a protective coating on the length of optical fiber; and
a tension tester constructed and arranged to induce a predetermined amount of axial tension on the length of optical fiber, the tension tester including first and second clamps disposed adjacent first and second ends of the mold to clamp onto first and second end portions of the optical fiber extending outwardly from the first and second ends of the mold, each of the first and second clamps including a pair of flat clamp surfaces that are configured to clamp the first and second portions of the optical fiber therebetween.

85. The optical fiber recoater according to claim 84, further comprising a light guide supported adjacent the mold, the light guide being constructed and arranged to emit a light beam onto the mold to expose and cure the coating material in the molding cavity with the light beam.

86. The optical fiber recoater according to claim 85, wherein the light guide is movable relative to the mold to progressively cure the coating material.

87. The optical fiber recoater according to claim 86, wherein the light guide is movable in response to a control signal.

88. The optical fiber recoater according to claim 84, further comprising first and second fiber supports disposed adjacent first and second ends of the mold, the first and second fiber supports being constructed and arranged to support the length of optical fiber along the molding axis.

89. The optical fiber recoater according to claim 88, wherein the first and second fiber supports are configured to open and close about the length of optical fiber in response to a control signal.

90. The optical fiber recoater according to claim 89, wherein each of the first and second fiber supports includes a centralizing clamp that is constructed and arranged to position each of a plurality of optical fibers coaxial with the molding axis, each of the plurality of optical fibers having an outer diameter that differs from an outer diameter of others of the plurality of optical fibers.

91. The optical fiber recoater according to claim 84, wherein the tension tester is configured to induce the predetermined amount of axial tension in response to a control signal.

92. The optical fiber recoater according to claim 91, wherein the first and second clamps are movable independent of each other in a direction parallel to the molding axis.

93. The optical fiber recoater according to claim 92, wherein the first clamp is coupled to a drive mechanism constructed and arranged to move the first clamp in response to the control signal.

94. The optical fiber recoater according to claim 93, wherein the second clamp is coupled to a tension monitor that is adapted to measure the amount of axial tension.

95. The optical fiber recoater according to claim 84, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

96. The optical fiber recoater according to claim 95, wherein the first and second molds are moveable in response to a control signal.

97. An optical fiber recoater, comprising:
a mold having a mold cavity adapted to enclose a length of optical fiber along a molding axis, the mold being adapted to receive a coating material in the molding cavity to form a protective coating on the length of optical fiber; and
first and second centralizing clamps disposed adjacent first and second ends of the mold, the first and second centralizing clamps being constructed and arranged to position each of a plurality of optical fibers coaxial with the molding axis, each of the plurality of optical fibers having an outer diameter that differs from an outer diameter of others of the plurality of optical fibers.

98. The optical fiber recoater according to claim 97, wherein each of the first and second centralizing clamps includes first and second clamp jaws movably supported relative to the molding axis between an open position and a closed position to hold any one of the plurality of fibers therebetween, each of the first and second clamp jaws including at least first and second clamping surfaces, the first clamping surface being angled with respect to the second clamping surface.

99. The optical fiber recoater according to claim 97, further comprising a light guide supported adjacent the mold, the light guide being constructed and arranged to emit a light beam onto the mold to expose and cure the coating material in the molding cavity with the light beam.

100. The optical fiber recoater according to claim 99, wherein the light guide is movable relative to the mold to progressively cure the coating material.

101. The optical fiber recoater according to claim 100, wherein the light guide is movable in response to a control signal.

102. The optical fiber recoater according to claim 97, wherein the first and second centralizing clamps are configured to open and close about the length of optical fiber in response to a control signal.

103. The optical fiber recoater according to claim 97, further comprising a tension tester constructed and arranged to induce a predetermined amount of axial tension on the length of optical fiber.

104. The optical fiber recoater according to claim 103, wherein the tension tester is configured to induce the predetermined amount of axial tension in response to a control signal.

105. The optical fiber recoater according to claim 97, wherein the mold includes a first mold and a second mold disposed opposite each other with the molding axis therebetween, each of the first and second molds being movable toward the molding axis to enclose the length of optical fiber in the molding cavity and away from the molding axis to release the length of optical fiber from the molding cavity.

106. The optical fiber recoater according to claim 105, wherein the first and second molds are moveable in response to a control signal.
